(19) United States
(12) Patent Application Publication
(10) Pub. No.: US 2009/0147496 A1
(43) Pub. Date: Jun. 11, 2009

(54) REAR MOUNT SHAFTLESS MOTOR AND LIGHTING SYSTEM

(76) Inventors: David Sziraki, Lincoln Park, MI (US); Alfeu Doria, Shanghai (CN); Toney Dong, Shanghai (CN); Xiaohui Xiong, Shanghai (CN); Yong Yi, Shanghai (CN)

Correspondence Address: FRASER CLEMENS MARTIN & MILLER LLC, 28366 KENSINGTON LANE, PERRYSBURG, OH, 43551, US

(21) Appl. No.: 11/952,635

(22) Filed: Dec. 7, 2007

(51) Int. Cl. G01D 7/00

(52) U.S. Cl. 362/23

(57) ABSTRACT

A motor and lighting system and method for mounting the motor and lighting system to the instrument cluster are disclosed, wherein the motor and lighting system includes a light source disposed on a rear side of a printed circuit board, the light source in electrical communication with a source of electrical energy and a motor having an aperture formed therein and disposed on the rear side of the printed circuit board, light emitted from the light source passing through the aperture of the motor.

### FIELD OF THE INVENTION

The present invention relates to an instrument cluster. More particularly, the invention is directed to a motor and lighting system and a method for mounting the motor and lighting system to the instrument cluster.

### BACKGROUND OF THE INVENTION

Instrument pointers in automotive instrument clusters indicate information to a driver such as speed and temperature, for example. The pointers are typically driven by a motor and illuminated by an LED.

There are generally two types of motors used in cooperation with an instrument cluster pointer. One is a shafted motor, and the other is a shaftless motor. The current automotive cluster market combines the motor with the LED in one of two ways.

First, the shafted motor is mounted on a rear side of a printed circuit board and the LED is mounted on a front side of a printed circuit board. This type of motor-LED combination is referred to as a rear mount shafted motor and a front mount LED.

The rear mount shafted motor and a front mount LED combination is beneficial to cluster structure design, since the combination does not occupy space on the front side of the printed circuit board. However, the rear mount shafted motor and a front mount LED combination has a disadvantage that a substantial portion of the light emitted from the LED is wasted (more than 70%), resulting in an undesirable illumination of the instrument pointer. Therefore, it is necessary to incorporate multiple LEDs to sufficiently illuminate the instrument pointer.

Second, the shaftless motor is mounted on the front side on the printed circuit board and the LED is mounted on the front side on the printed circuit board. This type of motor-LED combination is referred to as a front mount shaftless motor and front mount LED.

The front mount shaftless motor and front mount LED utilize a substantial portion of the light emitted from the LED (more than 90%). A single LED will illuminate the instrument pointer to a desirable level, thereby eliminating the need for multiple LEDs. However, the front mount shaftless motor and front mount LED occupies an undesirable amount of space on the front side of the printed circuit board. This combination limits the illumination of the instrument gauge and is not suitable for instrument clusters incorporating a telltale that is close to the pointer center.

It would be desirable to have a motor and lighting system and a method for mounting the motor and lighting system on a rear side of a printed circuit board of an instrument cluster, wherein the LED sufficiently illuminates an instrument pointer while minimizing structure disposed on the front side of the printed circuit board.

### SUMMARY OF THE INVENTION

Concordant and consistent with the present invention, a motor and lighting system and a method for mounting the motor and lighting system on a rear side of a printed circuit board of an instrument cluster, wherein the LED sufficiently illuminates an instrument pointer while minimizing structure disposed on the front side of the printed circuit board, has surprisingly been discovered.

In one embodiment, a motor and lighting system comprises a printed circuit board; a light source disposed on a rear side of the printed circuit board, the light source in electrical communication with a source of electrical energy; and a motor having an aperture formed therein and disposed on the rear side of the printed circuit board, light emitted from the light source passing through the aperture of the motor.

In another embodiment, a motor and lighting system for an instrument cluster comprises a printed circuit board; a light source disposed on a rear side of the printed circuit board, the light source in electrical communication with a source of electrical energy; and a rear mount shaftless motor having an aperture formed therein and disposed on the rear side of the printed circuit board, light emitted from the light source passing through the aperture of the motor.

The invention also provides methods for mounting a motor and light source to an instrument cluster.

One method comprises the steps of providing a light source in electrical communication with a source of electrical energy; providing motor having an aperture formed therein; disposing the motor on a rear side of a printed circuit board; and embedding the light source in the motor, wherein light emitted from the light source passes through the aperture of the motor.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is an exploded perspective view of a motor and lighting system in cooperation with an instrument pointer according to an embodiment of the present invention.

FIG. 2 is a sectional view of the motor and lighting system taken along line 2-2 in FIG. 1.

FIG. 3 is a front perspective view of the motor and lighting system illustrated in FIGS. 1 and 2.

FIG. 4 is a rear perspective view of the motor and lighting system illustrated in FIGS. 1, 2, and 3.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

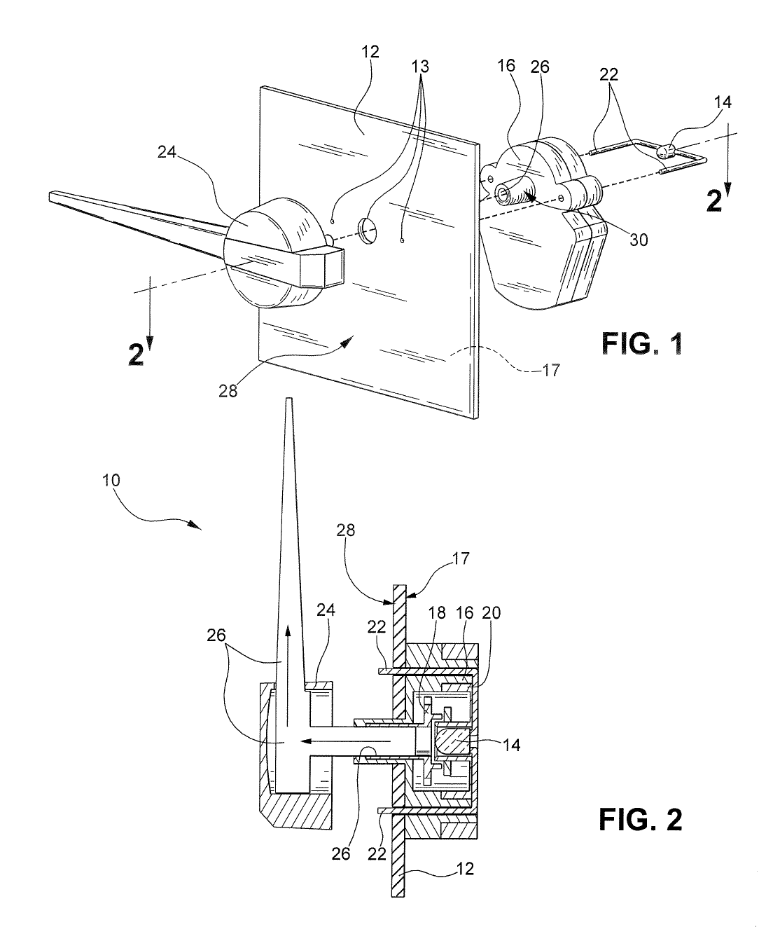

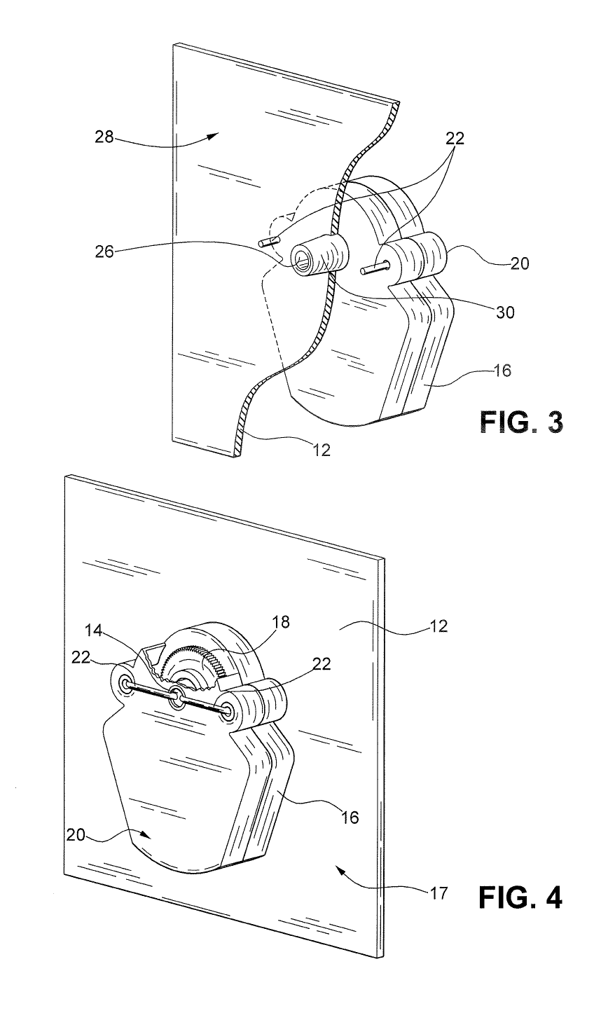

FIGS. 1, 2, 3 and 4 show a motor and lighting system 10 according to an embodiment of the present invention. The motor and lighting system 10 includes a printed circuit board (PCB) 12, a light source 14, and a motor 16. FIGS. 1 and 2 show the motor and lighting system 10 in cooperation with an instrument pointer 24 according to an embodiment of the present invention.

The PCB 12, also referred to as a printed wiring board, may be formed from any conventional PCB material such as FR4, for example. In the embodiment shown, the PCB 12 includes a plurality of PCB apertures 13. The PCB apertures 13 provide a means for at least a portion of the motor 16 to protrude through the PCB 12. The PCB apertures 13 further provide a means for electrical communication between the PCB 12 and electrical components such as the light source 14, for example. It is understood that the PCB 12 may be in electrical communication with an electrical component such as a controller and an electrical energy source, for example.

The light source 14 may be any conventional light source such as a light emitting diode (LED), for example. The light source 14 is disposed on a rear side 17 of the PCB 12 and in electrical communication with an electrical energy source (not shown). It is understood that the PCB 12 may provide electrical communication between the electrical energy source and the light source 14. In the embodiment shown, the light source 14 includes a plurality of electrical leads 22. The electrical leads 22 are formed to provide electrical communication between the light source 14 and the PCB 12. It is understood that the electrical leads 22 may be coupled to the PCB 12 using any conventional means of electrical coupling such as soldering, for example. The electrical leads 22 can also be coupled directly to the electrical energy source.

The motor 16 is disposed on the rear side 17 of the PCB 12 and is coupled to an instrument pointer 24. The instrument pointer 24 is disposed on the front side 28 of the PCB 12. Although the motor 16 is shown in cooperation with an instrument pointer 24, it is understood that the motor 16 may be adapted to control other indicator devices (not shown). In the embodiment shown, the motor 16 includes an output gear 18 adapted to control a rotational motion of the instrument pointer 24. As shown, the motor 16 is further adapted to receive the light source 14 and electrical leads 22 of the light source 14. A rear motor cover 20 protects the motor 16, the light source 14, and a substantial portion of the electrical leads 22 of the light source 14. The motor 16 shown in FIGS. 1 and 2 is a rear mount shaftless motor having a substantially frusto-conical protrusion 30 with an aperture 26 formed therein. The protrusion 30 provides a means for coupling the motor 16 to the instrument pointer 24. The aperture 26 provides a means for light emitted from the light source 14 to pass through the motor 16 and illuminate the instrument pointer 24. It is understood that the motor 16 may be any conventional motor such as a rear mount shaftless stepper motor, for example.

In use, the motor 16 controls the instrument pointer 24. Specifically, the motor 16 drives the output gear 18, wherein the output gear 18 controls the rotational motion of the instrument pointer 24. Light emitted from the light source 14 passes through the aperture 26 of the motor 16 and illuminates the instrument pointer 24. The motor and lighting system 10 according to the present invention sufficiently illuminates an instrument pointer 24, while minimizing structure disposed on the front side 28 of the printed circuit board 12.

The motor and lighting system 10 and method according to the present invention utilizes a substantial portion of the light emitted from the light source 14, thereby eliminating the need for multiple light sources to substantially illuminate the instrument pointer. In the embodiment shown, the motor and lighting system 10 utilizes more than 90% of the light emitted from the light source 14 by focusing the light through the aperture 26 of the motor 16 and directly into the instrument pointer 24. It is understood that systems having a higher or lower percentage of light usage can be provided without departing from the scope and spirit of the invention. The motor and lighting system 10 and method according to the present invention also minimize the complexity of the electrical circuitry of the instrument cluster, and increase ECAD area. Structure disposed on the front side 28 of the printed circuit board 12 is minimized and the motor and lighting system 10 and method are suitable for instrument clusters incorporating a telltale that is close to the pointer center.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A motor and lighting system comprising:
a printed circuit board having a first side and a second side;
a light source disposed on the first side of the printed circuit board, the light source in electrical communication with a source of electrical energy; and
a motor having an aperture formed therein and disposed on the first side of the printed circuit board, light emitted from the light source passing through the aperture of the motor.

2. The motor and lighting system according to claim 1, wherein the light source is a light emitting diode.

3. The motor and lighting system according to claim 1, wherein the motor is a rear mount shaftless motor.

4. The motor and lighting system according to claim 3, wherein the rear mount shaftless motor is a stepper motor.

5. The motor and lighting system according to claim 3, wherein the rear mount shaftless motor drives an instrument pointer disposed on the second side of the printed circuit board.

6. The motor and lighting system according to claim 5, wherein light emitted from the light source illuminates the instrument pointer.

7. The motor and lighting system according to claim 1, wherein the light source includes a plurality of electrical leads, the electrical leads of the light source providing electrical communication between the light source and the printed circuit board.

8. A motor and lighting system for an instrument cluster comprising:
a printed circuit board having a front side and a rear side;
a light source disposed on the rear side of the printed circuit board, the light source in electrical communication with a source of electrical energy; and
a rear mount shaftless motor having an aperture formed therein and disposed on the rear side of the printed circuit board, light emitted from the light source passing through the aperture of the motor.

9. The motor and lighting system according to claim 8, wherein the light source is a light emitting diode.

10. The motor and lighting system according to claim 8, wherein the light source is embedded in the rear mount shaftless motor.

11. The motor and lighting system according to claim 10, wherein the rear mount shaftless motor is a stepper motor.

12. The motor and lighting system according to claim 10, wherein the rear mount shaftless motor drives an instrument pointer disposed on the front side of the printed circuit board.

13. The motor and lighting system according to claim 12, wherein light emitted from the light source illuminates the instrument pointer.

14. The motor and lighting system according to claim 8, wherein the light source includes a plurality of electrical leads, the electrical leads of the light source providing electrical communication between the light source and the printed circuit board.

15. A method for mounting a motor and light source to an instrument cluster, the method comprising the steps of:
providing a light source in electrical communication with a source of electrical energy;
providing motor having an aperture formed therein;
disposing the motor on a rear side of a printed circuit board; and
embedding the light source in the motor, wherein light emitted from the light source passes through the aperture of the motor.

16. The method according to claim 15, wherein the light source is a light emitting diode.

17. The method according to claim 15, wherein the motor is a rear mount shaftless motor.

18. The method according to claim 17, wherein the rear mount shaftless motor is a stepper motor.

19. The method according to claim 17, wherein the rear mount shaftless motor drives an instrument pointer.

20. The method according to claim 19, wherein light emitted from the light source illuminates the instrument pointer.
